(19) United States
(12) Patent Application Publication
(10) Pub. No.: US 2008/0206128 A1
(43) Pub. Date: Aug. 28, 2008

(54) Process for recycling industrial waste magnesium oxide/magnesium hydroxide for use in magnesium oxide based cement/concrete and method of preparation

(76) Inventor: Judd Douglas Hamilton, Seattle, WA (US)

Correspondence Address: Judd Douglas Hamilton, 3033 CALIFORNIA AVE. SW # 116, SEATTLE, WA, 98116, US

(21) Appl. No.: 12/072,214

(22) Filed: Feb. 25, 2008

Related U.S. Application Data
(60) Provisional application No. 60/903,504, filed on Feb. 26, 2007.

(51) Int. Cl. C01F 5/14

(52) U.S. Cl. 423/636

(57) ABSTRACT

The inventor's discovery of recyclable Industrial Waste Magnesium Oxide/Magnesium Hydroxide materials, which are currently available from numerous magnesium based industrial processes/sources, as well as the identification of various state-of-the-art, contemporary and/or advanced materials dehydration and separation technologies, is intended to advance the cost-effective, eco-friendly, superior quality usefulness of Magnesium Oxide based cement concrete.

### CROSS REFERENCE

The present application claims priority under 35 U.S.C. §119(e) to U.S. Provisional Patent Application Ser. No. 60/903,504, filed on Feb. 26, 2007, which is hereby incorporated by reference in it's entirety.

### FIELD OF INVENTION

The present invention relates to the field of Magnesium Oxide/Phosphate-bonded cement/concrete, and particularly to the discovery and reprocessing of industrial waste Magnesium Oxide (MgO) and/or any derivative Magnesium Hydroxide (Mg(OH)₂ materials, into useful hard-burned/dead-burned Magnesium Oxide that has been and continues to be produced as a waste by-product from magnesium alloy ingot production, as well as other similar industrial calcination/manufacturing processes that employ magnesium baring raw materials. The present invention describes how this Industrial Waste Magnesium Oxide/Magnesium Hydroxide can be re-processed, recycled and employed as an essential raw material for making lower-cost Magnesium Oxide/Phosphate ceramic cement/concrete. The generally accepted value and superior quality of Magnesium Oxide/Phosphate based cement/concrete is exemplified in the following patent references.

### REFERENCES CITED

### References By

| | | |
|---|---|---|
| 2391493 | December 1945 | Wainer et al. |
| 3093593 | June 1963 | Arrance |
| 3357843 | December 1967 | Bowman |
| 3383228 | May 1968 | Rekate et al. |
| 3392037 | July 1968 | Neeley et al. |
| 3540897 | November 1970 | Martinet |
| 3647488 | March 1972 | Brigham et al. |
| 3879211 | April 1975 | Klotz |
| 3920464 | November 1975 | Damiamo |
| 3923534 | December 1975 | Cassidy |
| 3960580 | June 1976 | Stierli et al. |
| 3985567 | October 1976 | Iwu |
| 4160673 | July 1979 | Fujita et al. |
| 4275091 | June 1981 | Cassens, Jr. |
| 4298391 | November 1981 | Hayase et al. |
| 4347325 | August 1982 | Michel et al. |
| 4444594 | April 1984 | Paddison et al. |
| 4459156 | July 1984 | Henslee et al. |
| 4836854 | June 1989 | Bierman et al. |
| 4843044 | June 1989 | Neville et al. |
| 4921536 | May 1990 | Rechter |
| 4939033 | July 1990 | Daussan et al. |
| 5302565 | April 1994 | Crowe |
| 5382289 | January 1995 | Bambauer et al. |
| 5502268 | March 1996 | Cote et al. |
| 5518541 | May 1996 | Fogel et al. |
| 5645518 | July 1997 | Wagh et al. |
| 5650121 | July 1997 | Dody et al. |
| 5830815 | November 1998 | Wagh et al. |
| 5846894 | December 1998 | Singh et al. |
| 5645518 | July 1997 | Wagh et al. |
| 6133498 | October 2000 | Singh et al. |
| 6518212 | February 2003 | Wagh et al. |
| 6776837 | August 2004 | Wagh et al. |
| 6786495 | September 2004 | Lally |

### BACKGROUND OF INVENTION

‘Cold-fired’ Magnesium Oxide/Phosphate ceramic cement materials, such as those evidenced in the above referenced patents, offer unique qualities and sometimes significantly superior advantages over contemporary portland cement blends and various epoxy bonding systems and alternative cementitious formulations. All Magnesium Oxide/Phosphate cement formulas and blends may significantly benefit from the relatively ‘low-cost’, recyclable Magnesium Oxide materials obtained from the industrial waste Magnesium Oxide/Magnesium Hydroxide materials the present invention illustrates and describes.

To illustrate the unique value of the discovery and identification of useful sources of Industrial Waste Magnesium Oxide (MgO), to the best of the inventor's knowledge none of the currently known Magnesium Oxide/Phosphate cements and/or any relevant published patent applications claim to, nor do they describe and/or incorporate the use of the present inventions recycled, Industrial Waste Magnesium Oxide materials. Presently these Magnesium Oxide/Phosphate based cements entirely rely upon specially prepared and manufactured forms of relative high cost tech-grade, food grade Magnesium Oxide.

Cement/concrete admixtures made from hard-burned/dead-burned Magnesium Oxides and various suitable phosphate's are presently considered to be viable, and even superior quality, biocompatible, biodegradable, sustainable and/or ‘green’ cementitious alternatives for portland cement. The quality, usefulness and superior cementitious bonding results that can be obtained from Magnesium Oxide/Phosphate-bonded cement/concrete are well documented and scientifically proven. One of the restrictive factors in the widespread use of these superior Magnesium Oxide/Phosphate cements is the present and rising cost of the specially prepared Magnesium Oxide materials currently available, causing these MgO based ceramic cements to be significantly more expensive than portland cement.

From the beginning of what is commonly known as the Industrial Age, and continuing presently on a daily basis, wherever magnesium alloy ingots and/or other magnesium originated manufacturing processes exist, often large deposits of residue magnesium, referred to variously as hard-burned/dead-burned Magnesium Oxide (MgO), or in some cases a Magnesium Hydroxide derivative have been and continue to be produced and accumulated as a hitherto considered to be a useless waste by-product.

The present invention intends to identify the aforementioned Industrial Waste Magnesium Oxide materials and their suitability to create useful and cost-effective raw materials for the production of Magnesium Oxide/Phosphate-bonded cement/concrete by replacing the manufactured Magnesium Oxide (MgO) that is normally employed with reprocessed and recycled industrial waste Magnesium Oxide has long been stockpiled throughout the world as a hitherto useless industrial waste by-product.

The Industrial Waste Magnesium Oxide (MgO) material described in the present invention is primarily created as a by-product from the production and manufacture of magnesium alloy ingots and/or other similar magnesium based industrial process. By way of a description of one of the manufacturing processes that produce this useful waste MgO, magnesium alloy ingots are utilized in the manufacture of aluminum, steel, as well as other industrial manufacturing processes throughout the industrialized world. The production of magnesium alloy ingots require the high temperature calcining of magnesite and/or other magnesium baring ores and materials such as dolomite (calcium-magnesium-carbonate), forsterite (magnesium silicate), brucite (mineral of Magnesium Hydroxide), as well as Magnesium Hydroxide recovered from magnesia-bearing brines (seawater). Although it has previously remained unrecognized and unknown, useful forms of hard burned/dead burned Magnesium Oxide (MgO) and Magnesium Hydroxide (Mg(OH)₂ is produced as a waste by-product within these industrial processes. Therefore large quantities of waste Magnesium Oxide/Magnesium Hydroxide materials have built up over many decades, and continue to be produced and stored throughout the industrialized world.

Utilizing Magnesite Ore as a relative example to illustrate how the hard-burned/dead-burned Industrial Waste Magnesium Oxide (MgO) referred to in this document is produced; suitably prepared Magnesite is placed in specially designed rotary furnaces (kilns) and heated to temperatures that range between 1300 and 2000 degrees Centigrade. When the specially prepared Magnesite is heated to these temperature ranges it is chemically altered, liquefied and oxidizes into Magnesium Oxide so as to become malleable enough to be poured into molds and useful magnesium alloy ingots for industrial use. As the newly forming Magnesium Oxide is heated to temperatures above 1000 degrees Centigrade, particles of the molecularly altered, molten Magnesium Oxide are continuously released from the main body of the molten ore and fall into grated areas under the furnace kiln.

The furnace kilns are designed so as to enable the small grain sized bits of extraneous Magnesium Oxide particles to fall into the grated areas and be safely captured until the waste Magnesium Oxide (MgO) has cooled and re-solidified, at which point the waste MgO is periodically removed and disposed of by storing it above ground in large, mountainous piles, or converesly in specially prepared underground storage holes.

The aforementioned calcining process manifests a chemical alteration that transforms and oxidizes this residue magnesite material into a Magnesium Oxide reactant purity range of 88% to 98.2% (see MSDS description in clause 0011), which is often referred to as hard-burned or dead burned Magnesium Oxide.

Material Specification: Magnesium Oxide Grade “B” 5A/LST

This specification covers fused magnesium oxide (92% MgO minimum).

| | TYP | MIN | MAX |
|---|---|---|---|
| CHEMICAL | | | |
| ANALYSES: | | | |
| SiO₂ | 3.500 | 2.500 | 4.500 |
| CaO | 1.200 | 0.700 | 1.700 |
| FE₂O₂ | 0.100 | 0.000 | 0.200 |
| Al₂O₂ | 0.700 | 0.400 | 1.000 |
| MgO (BY DIFF) | 95.000 | 92.000 | 98.000 |
| IMPURITIES: | | | |
| Carbon PPM | 50 | 0 | 100 |
| Sulfur PPM | 25 | 0 | 50 |
| Boron PPM | 60 | | 100 |
| LOSS OF | | | |
| IGNITION | | | |
| ASTM D2773-69 | | | |
| (before treatment) | 0.01 | 0 | 100 |
| PHYSICAL | | | |
| PROPERTIES: | | | |
| A. Sieve Analysis | | | |
| ASTM D2755-68 | | | |
| D2772-69 | | | |
| % ON | 0.0 | 0.0 | 0.1 |
| 40 | | | |
| 60 | 32 | 25 | 39 |
| 100 | 27 | 21 | 33 |
| 200 | 27 | 21 | 33 |
| 325 | 9 | 6 | 12 |
| % through 325 | 5 | 3 | 7 |
| B. Tap Density: | | | |
| ASTM D3347-74 | | | |
| (grams/cc) | | 2.36 | 2.39 |
| C. Flow: | 175 | 160 | 190 |
| ASTM D3347-74 | | | |
| D. Magnetic | | | |
| Iron: | | | |
| (ppm) | 25 | 0 | 50 |
| THERMAL | | | |
| PROPERTIES: | | | |
| Sinter Index (g) | 25 | 0 | 50 |
| ASTM D3026-72 | | | |
| ELECTRICAL | | | |
| PROPERTIES: | | | |
| Specific | | 130 | |
| Resistance | | | |
| (M ohms-in.) | | | |
| ElectricalResistance | | | |
| (Megohms at | | | |
| 40 W/in2) | | | |
| per Universal | 7 | 3 | |
| American, Inc. | | | |
| test data | | | |

Must contain less than 0.1% silicone Fluid

Most industrial waste Magnesium Oxide will have extraneous and even detrimental mineral elements such as excess carbon or excess calcium, and/or other unwanted elements that can be separated out and removed by well known, conventional as well as state-of-the-art material processing technologies.

Magnesium Oxide/Phosphate-bonded ceramic cement is formed at or near ambient room temperatures (under one hundred degrees Celsius) via a water-activated exothermic reaction. All of the foregoing inventions/patents referenced, disclose a method of utilizing suitable Magnesium Oxide in combination with a phosphoric acid or other forms of phosphate to generate a resultant Magnesium Oxide/Phosphate composition (in the present example a tri-hydrated form). In an exemplary embodiment, the following Magnesium Oxide/Phosphoric acid reaction may be characteristic:
MgO+H₃PO₄+H₂O→MgHPO₄.3H₂O

The aforementioned Industrial Waste Magnesium Oxide can, in most instances, be improved by a combination of dehydration, extraneous element purification, and chemical alteration, so as to produce the desired chemistry/chemical content needed for Magnesium Oxide/Phosphate cement/concrete by utilizing currently available material processing/separation technologies, state-of-the-art vortex technologies (such as described in U.S. Pat. No. 6,971,594), as well as by utilizing other well-known material production methods, including the creation of nano-sized Magnesium Oxide/Phosphate cement binders.

(A previously described invention reference of a cementitous bonding principle that employs light-burned Magnesium Oxide as a raw material that would benefit from the cost-effectiveness of the present invention is evidenced in U.S. Pat. No. 4,158,570 entitled: Preparing Magnesium Oxychloride and/or Sulfate Cements. This invention employs the use of magnesium oxide as a key component in the preparation of the specific cements mentioned but also fails to recognize the use of the present invention's discovery and use of the cost-effective, recycled, and reprocessed source of industrial waste Magnesium Oxide claimed in the present invention.

All of the listed patent references and patent applications referred to in this document, and any other patents, patent applications, inventions and/or cementitious formulations that employ Magnesium Oxide as an essential raw material ingredient may significantly benefit from the proposed reduced cost of the present invention's identification of and reprocessing of the Industrial Waste Magnesium Oxide described and claimed within the present invention.

### SUMMARY OF INVENTION

The present invention is the result of the inventor uniquely identifying and researching an industrially produced Magnesium Oxide waste by-product material. After extensively testing and confirming the usefulness of these hitherto unidentified and available waste magnesium oxide materials, it became obvious that these waste MgO materials ideally conform to the MgO reactivity and qualities of the essential MgO needed for the production and manufacture of Magnesium Oxide based cement/concrete. The other necessary raw material needed to form the preferred ceramic cement binder is based on phosphate compositions including Monopotassium Phosphate (MKP), Monoammonium Phosphate (MAP), Ammonia Polyphosphate (APP), Phosphoric Acid, and other suitable forms of Phosphate. The resultant cements are known variously as Ceramic Cement, MgO Cement and Phosphate-Bonded Cement.

The present invention's Magnesium Oxide/Phosphate cement/concrete admixtures are created in exactly the same manner as all currently available Magnesium Oxide/Phosphate-bonded ceramic cement admixtures, which those skilled in the art will recognize. The present invention also recognizes the possible value of Industrial Waste Magnesium Oxide for use in Magnesium Oxychloride and Magnesium Oxysulfate cements, which are prepared in a distinctly different manner that the Magnesium Oxide/Phosphate cements.

### DETAILED DESCRIPTION OF INVENTION

Currently one of the prohibitive factors in expanding the usefulness and wide spread use of Magnesium Oxide/Phosphate based cements is their dependence on the retail cost/price of the specially manufactured and refined, tech grade, food grade Magnesium Oxide that is produced from magnesite, sea brine, and other naturally occurring magnesium baring materials. Therefore the specific benefit of the present invention's identification of the aforementioned industrial waste Magnesium Oxide materials, and the corresponding identification of well-known contemporary and state-of-the-art technologies for processing and recycling same, is the cost saving advantage these industrial waste Magnesium Oxide materials portend when compared to the manufactured and considerably higher priced tech-grade, food-grade Magnesium Oxide materials that are presently used to produce Magnesium Oxide based cement/concrete. Particularly as when these industrial waste Magnesium Oxide materials are cost-effectively re-processed and recycled they produce the same durable, high-strength, superior quality Magnesium Oxide/Phosphate ceramic cement/concrete as the more expensive, manufactured Magnesium Oxide.

1. The present invention claims the exclusive right to recycle and employ the use of any and all available ‘Industrial Waste’ Magnesium Oxide (MgO)/Magnesium Hydroxide (Mg(OH)₂ materials produced from any viable magnesium mineral source for use as an essential raw material within any and all magnesium based cements and concrete's formulas presently known, as well as any and all Magnesium Oxide based cement/concrete formulations that may in the future utilize these Industrial Waste Magnesium Oxide/Magnesium Hydroxide materials to produce useful Magnesium Oxide based Cement and Concrete.

2. The present invention claims the exclusive right to the use of any and all of the available and well-known and as yet unknown Materials Processing, Dehydration and Separation technologies that may be useful for cleaning up, preparing and recycling the Industrial Waste Magnesium Oxide/Magnesium Hydroxide referred to in claim 1, so as to release any built up and residual moisture, molecular water and/or extraneous materials that may be contained within the Industrial Waste Magnesium Oxide/Magnesium Hydroxide compositions, thereby obtaining the desired reactivity and necessary chemical qualities.

3. The present invention claims the exclusive right to the identification of and use of any known and/or unknown, advanced, state-of-the-art Material Processing, Dehydration and Separation technologies, including but not restricted to Vortex Materials Processing Systems, to ‘clean up’ and reduce the particle size of the Industrial Waste Magnesium Oxide/Magnesium Hydroxide materials to a particle size ranging from minus 30 mesh down to minus 1000 or below.

4. Based on the continuing value of the initial identification and research of the Industrial Waste Magnesium Oxide/Magnesium Hydroxide referred to in claim 1, the present invention also claims the exclusive right to utilize any and all relevant, known and or as yet unknown, nano-based technologies for the preparation, processing, recycling and use of the Industrial Waste Magnesium Oxide/Magnesium Hydroxide referred to in claim 1, so as to be able to continue to improve upon the inherent cementiious bonding characteristics of these Industrial Waste Magnesium Oxide/Magnesium Hydroxide materials.
